(19) United States
(12) Patent Application Publication
(10) Pub. No.: US 2003/0031110 A1
(43) Pub. Date: Feb. 13, 2003

(54) Optical disk having multiple write layers, optical disk manufacturing method, optical disk device and optical disk write/read method

(75) Inventor: Kenichi Ishizuka, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/206,321

(22) Filed: Jul. 29, 2002

(30) Foreign Application Priority Data
Aug. 8, 2001 (JP) 240851/2001

(51) Int. Cl. G11B 7/135

(52) U.S. Cl. 369/112.26; 369/283; 369/94

(57) ABSTRACT

An optical disk, a method for manufacturing an optical disk, an optical disk device and a method for writing/reading an optical disk, wherein the optical disk is of a write/read type having two layers of write films, enabling the state of the write/read beam to be kept constant when writing onto or reading out of a second write film without being affected by variations in the write state of a first write film, is to be provided. In an optical disk configured by stacking, enumerated in the direction of incidence of a write/read beam, a disk substrate, a first write film, an adhesive layer, a second write film, another disk substrate and an aluminum reflective layer, when performing read/write onto or out of a write film which is the second write film, the write/read beam is focused on the second write film after being transmitted by the disk substrate, the first write film, the adhesive layer, the second write film and the other disk substrate and reflected by the aluminum reflective layer.

### BACKGROUND OF THE INVENTION

The present invention relates to an optical disk, an optical disk manufacturing method, an optical disk device and an optical disk write/read method, and more particularly to an optical disk having multiple write layers, a manufacturing method therefor, an optical disk device using the disk and a write/read method for the optical disk.

### DESCRIPTION OF THE RELATED ART

Conventionally, an optical disk of this kind having multiple write layers, a manufacturing method therefor, an optical disk device using the optical disk and a write/read method for the optical disk are used for large-capacity writing.

FIG. 9 is a schematic diagram of the configuration of an objective lens and an optical disk in particular in the overall configuration of an optical disk according to the prior art having multiple write layers and an optical disk device for writing onto and reading out of the disk. The objective lens used here is a 0.6 t objective lens 12 (which means that the lens focuses on a write film at a distance of 0.6 mm from the optical disk surface). The 0.6 t objective lens 12 can focus on a first write film 130 which is positioned nearer and a second write film 131 which is farther by electric focal shifting, and switch the focus between them. The optical disk has a structure in which a disk substrate 20 of 0.6 mm in total thickness provided with grooves 190, the translucent write film 130, a 0.06 mm transparent adhesive layer 30, the translucent write film 131 of 0.6 mm in total thickness provided with the grooves 190 and a transparent disk substrate 21, enumerated in the direction of a write/read beam 150 in the order of its travel.

The write film 130 and the write film 131 here have thicknesses in the order of nanometers, less than 1/1000 of the disk substrate and accordingly negligible thicknesses. The dimensional proportions in FIG. 9 are illustrated differently from the actual to facilitate understanding.

Next will be described the operations of these objective lens and optical disk.

The write/read beam 150 of 3.0 mm in diameter, after passing the 0.6 t objective lens 12, comes incident on the optical disk. The write/read beam 150 is transmitted by the disk substrate 20, the write film 130 and the adhesive layer 30 in that order, and focuses on the write film 131. The write/read beam 150 then passes the reverse route to that of its incidence and reaches a detector (not shown) of the optical disk device.

A problem with this prior art is that, when the write/read beam is transmitted by the first write film 130 and focuses on the second write film 131 to write or read in the write/read type optical disk having two layers of write films, the state of the write/read beam reaching the second write film 131 becomes unstable. As a consequence, in writing, the size of the pits for writing is unstable and, in reading, the read error rate rises.

The reason is that, because the write state of the write films is varied before and after writing in a write/read type optical disk, the transmittance of the write/read beam is varied dependent on the write state of the first write film.

### SUMMARY OF THE INVENTION

An object of the present invention is to provide an optical disk, an optical disk manufacturing method, an optical disk device and an optical disk write/read method, wherein the optical disk is of a write/read type having two layers of write films, enabling the state of the write/read beam to be kept constant.

An optical disk according to the invention has, enumerated in the direction of incidence of a write/read beam, a first write layer, a second write layer and a relay reflective layer for reflecting the write/read beam.

Further, the optical disk may measure 0.6±0.03 mm from the surface of the optical disk to the first write layer, and the sum of the length from the surface of the optical disk to the relay reflective layer and that from the relay reflective layer to the second write layer may be 1.2±0.1 mm.

The optical disk is further provided with a first substrate, a transparent adhesive layer between the first write layer and the second write layer, and a second substrate behind the second write layer, enumerated in the direction of incidence of the write/read beam in the order of its travel.

In this optical disk, the thickness of the second substrate may be more than 0.3 mm but less than 1.2 mm.

A method for manufacturing an optical disk according to the invention comprises a first step of forming a first write layer on one face of a first substrate; a second step of forming a second write layer on one face of a second substrate; a third step of forming a relay reflective layer on one face of a third substrate; a fourth step of pasting together the first substrate and the second substrate with a transparent adhesive layer between them so that the first write layer and the second write layer be positioned inside; and a fifth step of pasting together the face of the second substrate, out of the first substrate and the second substrate pasted together, reverse to the pasted face and the relay reflective layer of the third substrate with a transparent adhesive layer between them so that these faces be positioned inside.

Also a method for manufacturing an optical disk according to the invention may comprise a first step of forming a first write layer on one face of a first substrate; a second step of forming a second write layer on one face of a second substrate; a third step of pasting together the first substrate and the second substrate with a transparent adhesive layer between them so that the first write layer and the second write layer be positioned inside; and a fourth step of forming a relay reflective layer over the face of the second substrate, out of the first substrate and the second substrate pasted together, reverse to the pasted face.

An optical disk write/read device according to the invention comprises an optical disk provided with, enumerated in the direction of incidence of a write/read beam in the order of its travel, a first substrate, a second substrate, and a relay reflective layer; a light emitting unit for emitting the write/read beam; a bifocal lens which, when writing onto or reading out of the first write layer is to be performed, focuses the write/read beam from the disk surface directly on the first write layer, or when writing onto or reading out of the second write layer is to be performed, focuses the beam on the second write layer after it is transmitted by the first write layer and the second write layer and reflected by the relay reflective layer; and a light receiving unit for receiving the write/read beam.

The optical disk write/read device may further comprise a lens, between the bifocal lens and the light receiving unit, for condensing the reflected read beam reflected after being focused on the first write layer or the second write layer on a pinhole, the pinhole, and the light receiving unit for receiving the write/read beam.

The optical disk write/read device may use an optical disk which measures 0.6±0.03 mm from the surface of the optical disk to the first write layer, and in which the sum of the length from the surface of the optical disk to the relay reflective layer and that from the relay reflective layer to the second write layer is 1.2±0.1 mm.

The optical disk write/read device may use an optical disk further comprising, enumerated in the direction of incidence of the write/read beam in the order of its travel, a first substrate, a transparent adhesive layer, and the relay reflective layer.

Also, the optical disk write/read device may use an optical disk provided with a second substrate whose thickness is greater than 0.3 mm but less than 1.2 mm.

A method for writing/reading an optical disk is a write/read method for an optical disk provided with, enumerated in the direction of incidence of a write/read beam in the order of its travel, a first write layer, a second write layer and a relay reflective layer, comprising steps of focusing the write/read beam, when writing onto or reading out of the first write layer is to be performed, from the disk surface directly on the first write layer, or performing read/write, when writing onto or reading out of the second write layer, with the write/read beam focused on the second write layer after it is transmitted by the first write layer and the second write layer and reflected by the relay reflective layer.

### BRIEF DESCRIPTION OF THE DRAWINGS

The novel features believed to be characteristic of the invention are set forth in the appended claims. The invention itself, however, as well as other features and advantages thereof, will be best understood by referring to the detailed description which follows, read in conjunction with the accompanying drawings, wherein:

FIG. 1 illustrates the configuration of an optical disk device and its optical disk in a first preferred embodiment of the present invention;

FIG. 2 is a schematic diagram of the configuration of an objective lens and the optical disk in particular in the overall configuration of the optical disk device and its optical disk in the first preferred embodiment of the invention;

FIG. 3A illustrates a manufacturing method for the optical disk in the first embodiment of the invention;

FIG. 3B illustrates the manufacturing method for the optical disk in the first embodiment of the invention;

FIG. 3C illustrates the manufacturing method for the optical disk in the first embodiment of the invention;

FIG. 3D illustrates the manufacturing method for the optical disk in the first embodiment of the invention;

FIG. 3E illustrates the manufacturing method for the optical disk in the first embodiment of the invention;

FIG. 3F illustrates the manufacturing method for the optical disk in the first embodiment of the invention;

FIG. 4A illustrates the manufacturing method for the optical disk in the first embodiment of the invention;

FIG. 4B illustrates the manufacturing method for the optical disk in the first embodiment of the invention;

FIG. 4C illustrates the manufacturing method for the optical disk in the first embodiment of the invention;

FIG. 4D illustrates the manufacturing method for the optical disk in the first embodiment of the invention;

FIG. 5 illustrates the configuration of an optical disk device and its optical disk in a second preferred embodiment of the invention;

FIG. 6 is a schematic diagram of the configuration of an objective lens and the optical disk in particular in the overall configuration of the optical disk device and its optical disk in the second preferred embodiment of the invention;

FIG. 7A illustrates a characteristic part of a manufacturing method for the optical disk in the second embodiment of the invention;

FIG. 7B illustrates in another aspect the characteristic part of the manufacturing method for the optical disk in the second embodiment of the invention;

FIG. 8 illustrates an application of the first and second preferred embodiments of the invention to a double-side system with two layers on each side, and

FIG. 9 is a schematic diagram of the configuration of an objective lens and an optical disk in particular in the overall configuration of an optical disk according to the prior art having multiple write layers and an optical disk

### DESCRIPTION OF THE PREFFERED EMBODIMENTS

Next will be described in detail the first preferred embodiment of the present invention.

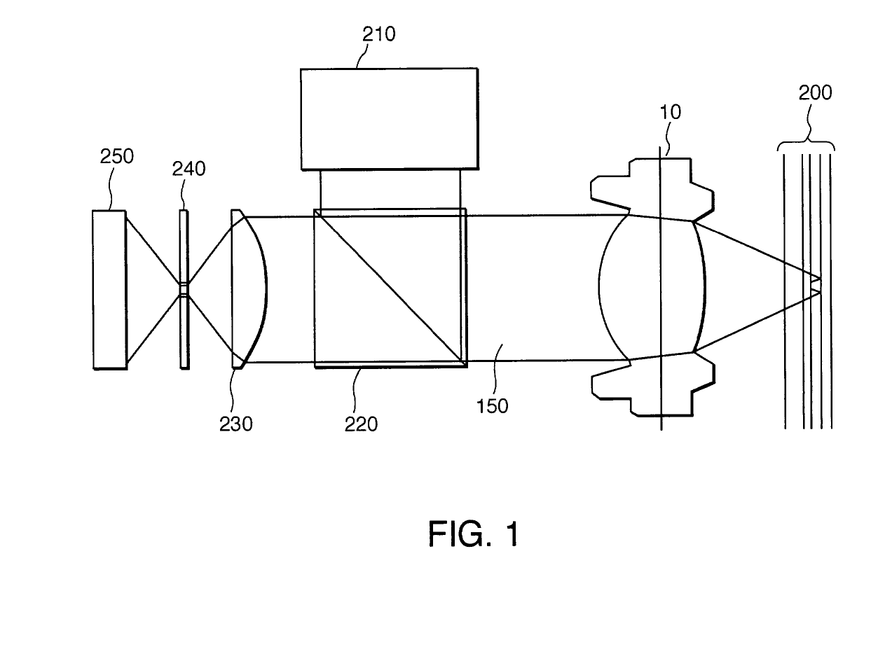

FIG. 1 illustrates the configuration of the optical disk device and its optical disk in the first preferred embodiment of the invention. The optical disk device is provided with a laser diode 210 serving as the light source, a beam splitter 220 for separating an incident light and a reflected light from each other, a 0.6 t/1.2 t bifocal objective lens 10 for focusing a beam on a reflection plane, an optical disk 200 having a write film and a reflection film each of two layers, a recondensing lens 230 for condensing the beam on a pinhole section 240, the pinhole section 240 having a pinhole of a few tens of microns for separating stray light, a photodetector 250 for reading data, and a write/read beam 150.

Next will be described the operations of the optical disk device and the optical disk in the first preferred embodiment of the invention.

The write/read beam 150 emitted from the laser diode 210 passes the beam splitter 220 and the 0.6 t/1.2 t bifocal objective lens 10, and comes incident on the optical disk 200. After being condensed onto and reflected by the write film of the optical disk 200, it again passes the 0.6 t/1.2 t bifocal objective lens 10, and passes the beam splitter 220 in the light receiving direction. It is focused by the recondensing lens 230 onto the pinhole of the pinhole section 240. Only that part of the write/read beam 150 having passed the pinhole section 240 reaches the photodetector 250 to enable data to be read.

The pinhole section 240 can transmit no other light than the reflected light focused by the 0.6 t/1.2 t bifocal objective lens 10 because it is not condensed by the pinhole section. This arrangement shuts out other return lights than that from the write layer on which the objective lens has focused.

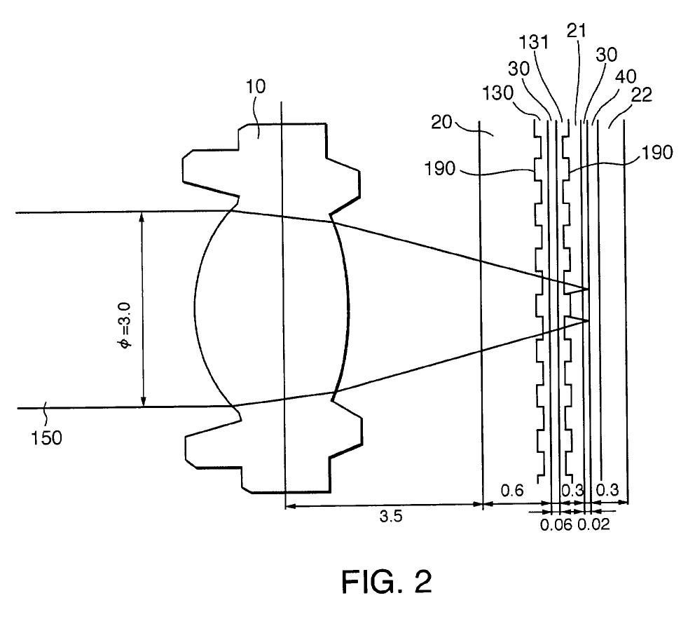

FIG. 2 is a schematic diagram of the configuration of the objective lens and the optical disk in particular in the overall configuration of the optical disk device and its optical disk in the first embodiment of the invention. As the objective lens, the 0.6 t/1.2 t bifocal objective lens 10 is used. The 0.6 t/1.2 t bifocal objective lens 10 may be either a double lens type (which meets the bifocal need by switching between two laterally arranged lenses according to the point to be focused on) or a hologram type (which differs between the central part and the peripheral part of the lens in the position where the transmitted light is focused; in this case, where the write/read beam is transmitted by the central part of the lens when it is to serve as a 1.2 t lens or by the peripheral part of the lens when it is to serve as a 0.6 t lens). The 0.6 t/1.2 t bifocal objective lens 10 is a bifocal objective lens whose tolerance is 0.6±0.03 mm when the lens is used for 0.6 t focusing or 1.2±0.1 mm for 1.2 t focusing.

The optical disk has a structure in which there are stacked, enumerated in the direction of the write/read beam in the order of its travel, a polycarbonate disk substrate 20 of 0.6 mm in thickness, provided with grooves 190; a translucent write film 130; a 0.06 mm transparent adhesive layer 30; a translucent write film 131 of 0.3 mm in total thickness; a polycarbonate disk substrate 21 provided with the grooves 190; another 0.06 mm transparent adhesive layer 30; an aluminum reflective layer 40 of 0.3 mm in thickness and 60% or more in reflection factor; and a disk substrate 22. The thicknesses of the write film 130, the write film 131 and the aluminum reflective layer 40 are in the order of nanometers, less than 1/1000 of the disk substrate and accordingly negligible thicknesses. The dimensional proportions in FIG. 2 are illustrated differently from the actual to facilitate understanding.

Next will be described the operations of these objective lens and optical disk.

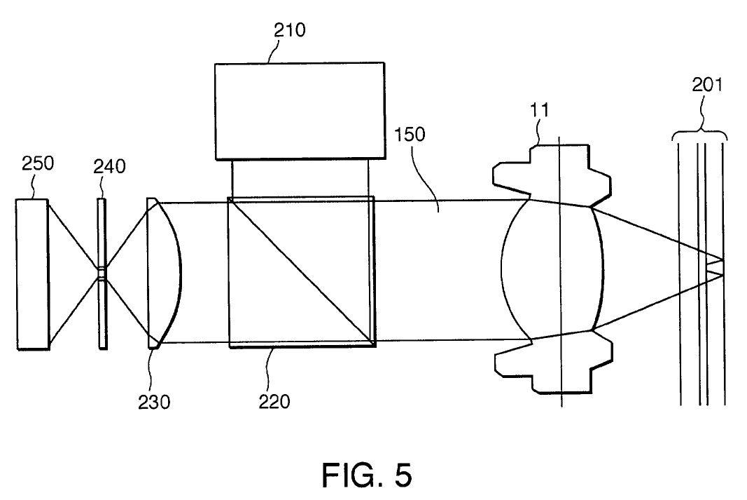

The write/read beam 150 of 3.0 mm in diameter, after being transmitted by the 0.6 t/1.2 t bifocal objective lens 10, comes incident on the optical disk positioned at a working distance (the distance from the center of the objective lens to the object, which means here the distance from the center of the objective lens to the surface of the optical disk) of 3.5 mm, is transmitted by the disk substrate 20, the write film 130, the adhesive layer 30, the write film 131, the disk substrate 21 and the adhesive layer 30 in that order, and reflected by the aluminum reflective layer 40. After reflection, it is transmitted by the adhesive layer 30 and the disk substrate 21, and focuses on the write film 131. After that, it passes the path shown in FIG. 5 and reaches the photodetector 250.

Next will be described in detail a method of forming this optical disk.

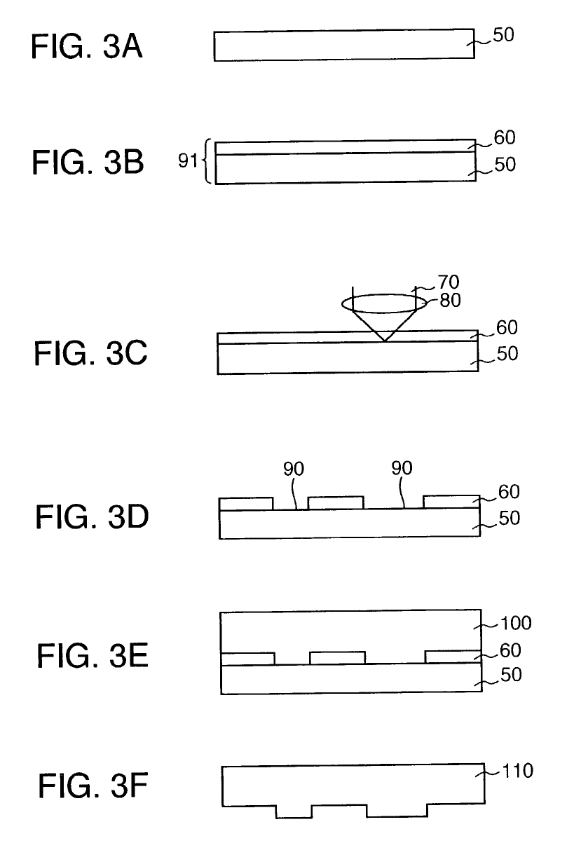

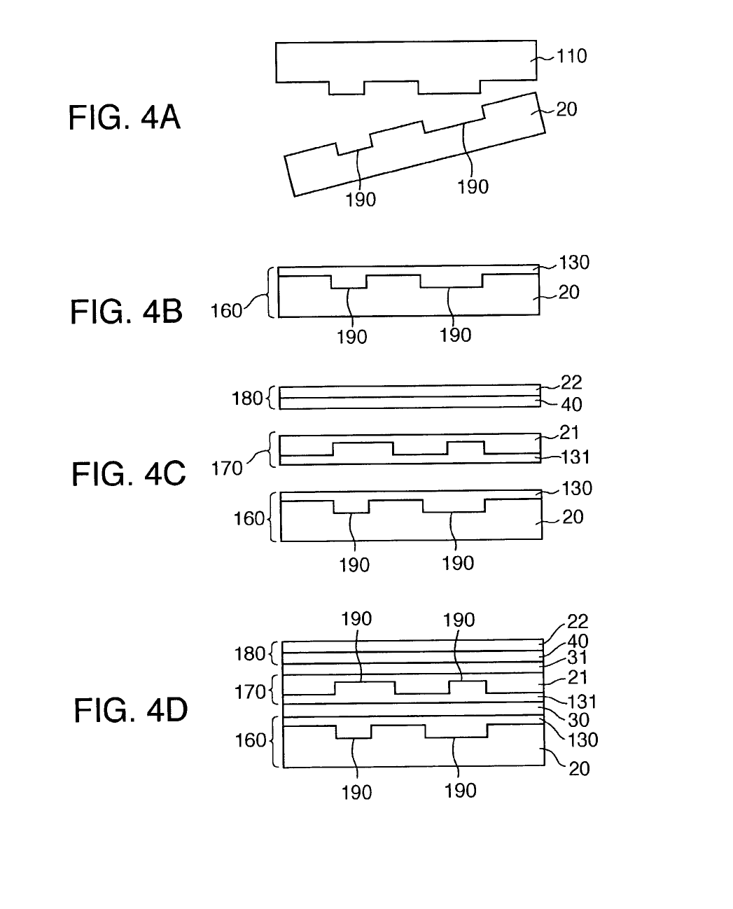

FIG. 3 and FIG. 4 illustrate a manufacturing method for the optical disk in the first preferred embodiment of the invention.

As shown in FIG. 3A, a smooth disk-shaped glass substrate 50 of 200 mm in diameter and 6 mm in thickness is polished and washed. Then, as shown in FIG. 3B, the glass substrate 50 is coated with a photoresist 60 of about 1000 Å in film thickness. This glass substrate 50 coated with the photoresist 60 will hereinafter be referred to as a mother disk 91. Next, as shown in FIG. 3C, the photoresist 60 is exposed to light using a laser beam 70 for exposure transmitted by an optical head 80 to be imprinted with a pattern of grooves and pre-pits (which are addresses pre-written in a physical shape of ups and downs of the disk surface because grooves alone cannot identify positions on the disk).

Then, as shown in FIG. 3D, an exposure pattern 90 is formed by development. Next, as shown in FIG. 3E, a metal layer 100 is formed over the developed mother disk by sputtering and electrocasting. Then, as shown in FIG. 3F, the metal layer 100 is peeled off to obtain a stamper 110.

Next, as shown in FIG. 4A, the stamper 110 is fitted to an injection molding machine (not shown) mounted with a 0.6 mm thick mold for use with optical disks, and the disk substrate 20 of 0.6 mm in thickness is injection-molded from a polycarbonate material of 1.55 in refractive index. The grooves 190 are formed in the disk substrate 20.

Then, as shown in FIG. 4, the write film 130 is formed on the face where the pattern has been imprinted by the stamper to make a first-layer disk 160. The write film 130 consists of a phase change film whose chemical formula is Ge2Sb2Te5, more strictly whose chemical composition (in which the ratio of the numbers of elements is represented) is Ge:Sb:Te=21:26:53 and a dielectric film of ZnS—SiO2. The most efficient films can be obtained by so adjusting the thickness of each film as to make the transmittance of the write/read beam relative to the write film 130 of the first-layer disk about 88% and the transmittance of the write/read beam relative to the write film 131 of a second-layer disk about 67%.

Next, as shown in FIG. 4C, similarly to what is illustrated in FIG. 4A, the stamper 110 is fitted to an injection molding machine (not shown) mounted with a 0.3 mm thick mold for use with optical disks, and a disk substrate of 0.3 mm in thickness is injection-molded. Then, similarly to what is illustrated in FIG. 4B, the write film 131 is formed over it to make a second-layer disk 170. Further, the aluminum reflective layer 40 of no less than 60% in reflection factor is formed over one face of the disk substrate 22 to make a dummy plate 180.

Then, as shown in FIG. 4D, the first-layer disk 160 and the second-layer disk 170 are pasted together with the 0.06 mm transparent adhesive layer 30 between them, and so are the second-layer disk 170 and the dummy plate 180 with a 0.02 mm transparent adhesive layer 31 between them.

Referring to this preferred embodiment of the invention, an optical disk, an optical disk manufacturing method, an optical disk device and an optical disk write/read method of the phase change type have been described, but this is not the only available type, but the invention can be implemented in any write/read type. For instance, if the write film is formed of TbFeCo, this mode of implementing the invention can be applied to a photomagnetic writing system, or to a write-once system if it is formed of an organic pigment.

Thus, in this embodiment of the invention, the write/read beam is transmitted by a first write layer and a second write layer and, after being reflected by a relay reflective layer, is brought into focus on the second write layer. For this reason, the sectional area of the write/read beam when it is transmitted by the first write layer is significantly greater than where no relay reflective layer is used.

The ratio between the spot diameter on the second layer when the beam focuses on the second-layer write film and that on the first write layer when transmitting the beam is “the spot diameter on the second layer/the spot diameter on the first layer=1:417”. As “the spot diameter on the second layer/the spot diameter on the first layer=1:44” according to the prior art, the present invention provides an approximately 9.5 times as great a spot diameter, i.e. almost 10 times as great. As the spot area ratio is square of the one-dimensional ratio, it is about 90 times as large as what the prior art provides.

Further, while the thickness of the disk substrate which transmits the write/read beam after the beam comes incident on the optical disk is 0.6 mm for the first-layer write film, that for the second-layer write film is 1.2 mm.

The standard on the disk substrate thickness is from 1.2+0.3 mm to 1.2−0.1 mm for CDs, the tolerance being greater on the plus side in consideration of the thicknesses of the protective film and label printing. Subtracting this special allowance, the distance from the CD surface to the write film is 1.2±0.1 mm. The standard on the disk substrate thickness is from 1.2+0.3 mm to 1.2−0.06 mm for DVDs. Again subtracting the allowance for the thicknesses of the protective film and label printing, the distance from the surface of a DVD having a write film at the center of the disk substrate to the write film 0.6±0.03 mm. The objective lenses for combined DVD/CD drives extensively manufactured at the time of filing the present application conformed to these standards.

Since the 0.6 t/1.2 t bifocal objective lens 10 used in the first embodiment of the invention satisfies this condition, this embodiment has an advantage of allowing the objective lens of any combined DVD/CD drive extensively manufactured at the time of filing the present application to be used as it is as the 0.6 t/1.2 t bifocal objective lens 10.

Also, as the thickness of the disk substrate that transmits the write/read beam after the beam comes incident on the optical disk is only 1.2 mm, rather small relative to that of the second-layer write film, the first embodiment of the invention has a further advantage of being able to maintain high-density writing because it is hardly susceptible to the impact of the coma.

Since the write/read beam 150 in the first embodiment of the invention is transmitted by the write film 131 twice more than according to the prior art from the time it comes incident on the optical disk 200 and focuses on the write film 131 until it again goes out of the optical disk 200, it is more likely for stray light (other components of light than what has focused and is reflected) to get mixed into the reflected light. However, the first embodiment of the invention is so configured that the reflected write/read beam 150 be caused by the recondensing lens 230 to focus on the pinhole of the pinhole section 240, and only that part of the write/read beam 150 having passed the pinhole section 240 reaches the photodetector 250 to read data. As a result, the first embodiment of the invention can distinguish between stray light and the reflected light, thereby making possible relatively noise-free data reading.

Although a structure in which are stacked the disk substrate 20 and the write film 130 having a combined thickness of 0.6 mm, the transparent adhesive layer 30 of 0.06 mm in thickness, the translucent write film 131 and the disk substrate 21 having a combined thickness of 0.3 mm, the transparent adhesive layer 30 of 0.06 mm in thickness, and the aluminum reflective layer 40 and the disk substrate 22 having a combined thickness of 0.3 mm has been presented as the first embodiment of the invention, the thicknesses of the constituent members are not limited to these values. The thickness of each member can be varied as desired by using an optical design for an optical pickup (not shown) or the like, though the objective lens of a combined DVD/CD drive could not be used then.

Next will be described in detail a second preferred embodiment of the present invention.

FIG. 5 illustrates the configuration of an optical disk device and its optical disk in the second preferred embodiment of the invention. It comprises the laser diode 210 serving as the light source, the beam splitter 220 for separating the incident light and the reflected light from each other, a 0.6 t/1.8 t bifocal objective lens 11 for focusing the beam on the reflection plane, an optical disk 201 having two layers of write films and a reflection film, the recondensing lens 230 for condensing the beam on the pinhole section 240, the pinhole section 240 provided with a pinhole of a few tens of microns for separating stray light, the photodetector 250 for reading data, and the write/read beam 150.

Next will be described the operations of the optical disk device and the optical disk in the second preferred embodiment of the invention.

The write/read beam 150 emitted from the laser diode 210 passes the beam splitter 220 and the 0.6 t/1.8 t bifocal objective lens 11, and comes incident on the optical disk 201. After being condensed onto and reflected by the write film of the optical disk 201, it again passes the 0.6 t/1.8 t bifocal objective lens 11, and passes the beam splitter 220 in the light receiving direction. It is focused by the recondensing lens 230 onto the pinhole of the pinhole section 240. Only that part of the write/read beam 150 having passed the pinhole section 240 reaches the photodetector 250 to enable data to be read.

The pinhole section 240 can transmit no other light than the reflected light focused by the 0.6 t/1.8 t bifocal objective lens 11 because it is not condensed by the pinhole section. This arrangement shuts out other return lights than that from the write layer on which the objective lens has focused.

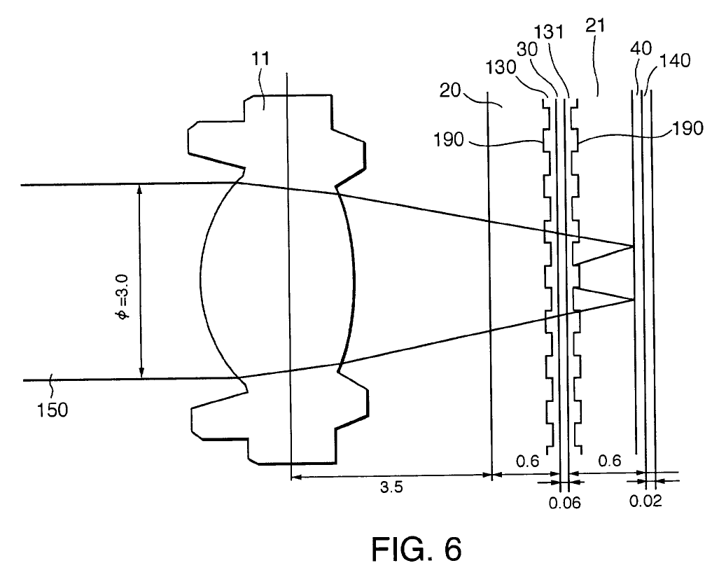

FIG. 6 is a schematic diagram of the configuration of the objective lens and the optical disk in particular in the overall configuration of the optical disk device and its optical disk in the second embodiment of the invention. As the objective lens, the 0.6 t/1.8 t bifocal objective lens 11 is used. The 0.6 t/1.8 t bifocal objective lens 11 may be either a double lens type or a hologram type. The optical disk has a structure in which there are stacked, enumerated in the direction of the write/read beam comes incident in the order of its travel, the transparent disk substrate 20 and the translucent write film 130 provided with the grooves 190, having a combined thickness of 0.6 mm; the transparent adhesive layer 300 of 0.06 mm in thickness; the translucent write film 131, the transparent disk substrate 21 provided with the grooves 190 and the aluminum reflective layer 40 of 60% or more in reflection factor, having a combined thickness of 0.6 mm; and a protective film 140 of 0.02 mm in thickness.

The thicknesses of the write film 130, the write film 131 and the aluminum reflective layer 40 are in the order of nanometers, less than 1/1000 of the disk substrate and accordingly negligible thicknesses. The dimensional proportions in FIG. 6 are illustrated differently from the actual to facilitate understanding.

Next will be described the operations of these objective lens and optical disk.

The write/read beam 150 of 3.0 mm in diameter, after being transmitted by the 0.6 t/1.8 t bifocal objective lens 11, comes incident on the optical disk positioned at a working distance of 3.5 mm, is transmitted by the disk substrate 20, the write film 130, the adhesive layer 30, the write film 131 and the disk substrate 21 in that order, and reflected by the aluminum reflective layer 40. After reflection, it is transmitted by the disk substrate 21, and focuses on the write film 131. After that, it passes the path shown in FIG. 5 and reaches the photodetector 250.

Next will be described in detail a method forming this optical disk.

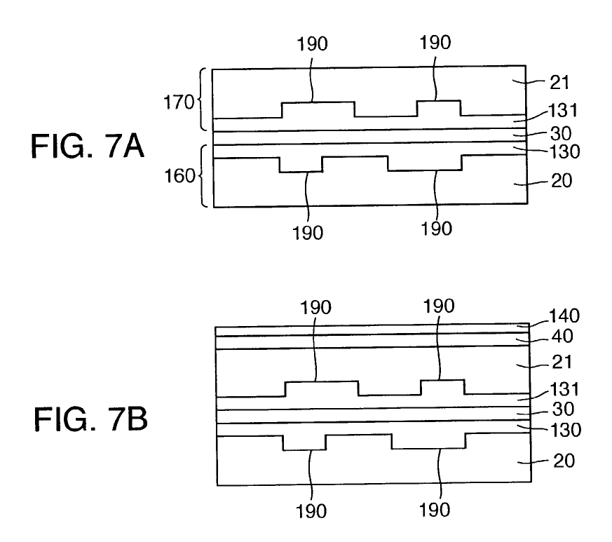

FIG. 7 illustrate a characteristic part of the manufacturing method for the optical disk in the second embodiment of the invention. As shown in FIG. 7A, the first-layer disk 160 and the second-layer disk 170, each 0.06 mm thick, are pasted together with the transparent adhesive layer 30 between them.

Then, as shown in FIG. 7B, after the aluminum reflective layer 40 is formed on the side reverse to the adhesive face of the second-layer disk 170, the protective film 140 is formed of an ultraviolet-setting resin.

Referring to this preferred embodiment of the invention, though an optical disk, an optical disk manufacturing method, an optical disk device and an optical disk write/read method of the phase change type have been described, this is not the only available type, but the invention can be implemented in any write/read type. For instance, if the write film is formed of TbFeCo, this mode of implementing the invention can be applied to a photomagnetic writing system, or to a write-once system if it is formed of an organic pigment.

Thus, in this second embodiment of the invention, the first-layer disk 160 and the second-layer disk 170 are 0.6 mm thick each. While in the first embodiment the distance over which the write/read beam 150 travels from the point it is transmitted by the first write layer 130 until it is focused on the second write layer 131 after being reflected by the reflective layer is 0.6 mm, the corresponding distance in the second embodiment is 1.2 mm.

As a result, the ratio between the spot diameter on the second layer when the beam focuses on the second-layer write film 131 and that on the first write layer 130 when transmitting the beam is “the spot diameter on the second layer/the spot diameter on the first layer=1:706”. As “the spot diameter on the second layer/the spot diameter on the first layer=1:44” according to the prior art, the present provides an approximately 16 times as great a spot diameter. As the spot area ratio is square of the one-dimensional ratio, it is about 260 times as large as what the prior art provides. Even compared with the first embodiment of the invention, in this second embodiment the ratio of the area in which the writing state has varied to the transmitted beam is about four times as great, resulting in the advantage that the capability to ease the variation in the transmittance of the write/read beam due to a variation in the writing state of the first write layer is further enhanced.

This advantage is achieved by making the distance over which the write/read beam travels from the point it is transmitted by the first-layer write film until it is focused on the second-layer write film greater than 0.6 mm, because the corresponding distance in the first embodiment is 0.6 mm.

Thus, it is sufficient for the thickness of the disk substrate 21, which is the second disk substrate counted in the direction of incidence of the write/read beam in the second embodiment, to be not less than 0.3 mm when the two-way travel of the write/read beam to and from the disk substrate 21 as a result of reflection is taken into account.

Also, as the number of disks is two in the second embodiment, less than in the first embodiment which uses three, the disk structure is simpler, and accordingly the disks have to be pasted together only once, resulting in facilitation of the disk manufacturing process.

Although a structure in which are stacked the disk substrate 20 and the write film 130 having a combined thickness of 0.6 mm, the transparent adhesive layer 30 of 0.06 mm in thickness, the write film 131 and the disk substrate 21, the aluminum reflective layer 40 and the protective film 140 having a combined thickness of 0.6 mm has been presented as the second embodiment of the invention, the thicknesses of the constituent members are not limited to these values. The thickness of each member can be varied as desired by using an optical design for an optical pickup (not shown) or the like.

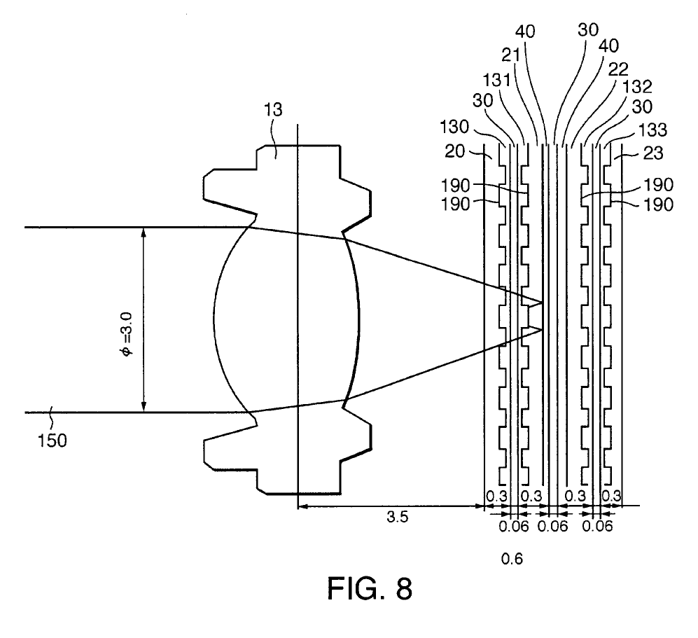

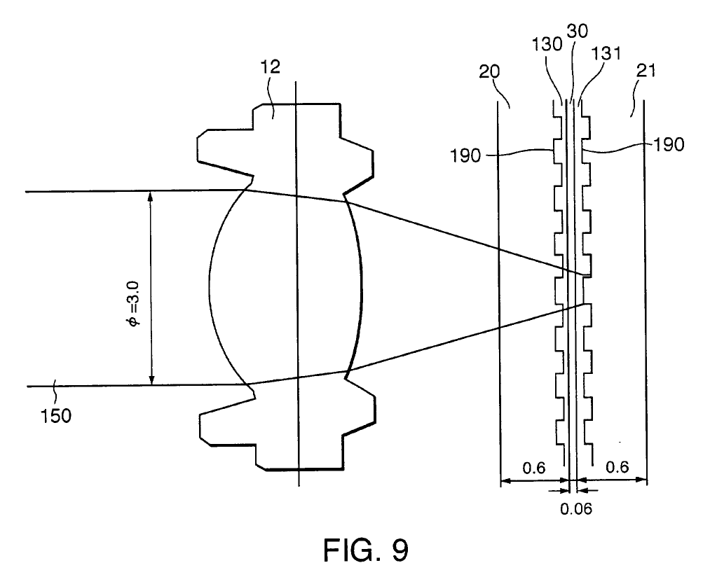

Although the foregoing description of the first and second preferred embodiments of the invention referred to optical disks, optical disk manufacturing methods, optical disk devices and optical disk write/read methods using single-side two-layered structures, the invention is not limited to this kind of structure. For instance, as shown in FIG. 8, the invention can as well be applied to a double-side system with two layers on each side. As illustrated in FIG. 8, altogether four each of disk substrates provided with the grooves 190 and write films having a combined thickness of 0.3 mm are pasted together with adhesive layers between them to form the double-side structure with two layers on each side. For a design in these dimensions, a 0.3 t/0.9 t bifocal objective lens is used as the objective lens.

Although the description of the first and second embodiments of the invention supposed the use of two write layers on one side, the number of write layers on one side is not limited to this, but the invention can as well be applied to a structure having three or more write layers.

An advantage of the present invention consists in that, when the write/read beam is transmitted by the first write film and focuses on the second write film to write or read in the write/read type optical disk having two layers of write films, the state of the write/read beam reaching the second write film 131 can be kept constant. In writing, the size of the pits for writing can be stabilized and, in reading, the error rate can be reduced.

The reason is explained below. The configuration of a write/read type optical disk having two layers of write films has, enumerated in the direction of the write/read beam comes incident in the order of its travel, a first write layer, a second write layer and a relay reflective layer. The write/read beam is transmitted by the first and second write layers and, after being reflected by the relay reflective layer, is brought into focus on the second write layer. For this reason, the sectional area of the write/read beam when it is transmitted by the first write layer is significantly greater than where no relay reflective layer is used. As a result, variations in the transmittance of the write/read beam dependent on the write state of the first write layer are evened out.

While this invention has been described with reference to illustrative embodiments thereof, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. An optical disk comprising, enumerated in the direction of incidence of a write/read beam:
a first write layer,
a second write layer and
a relay reflective layer for reflecting the write/read beam.

2. The optical disk, as claimed in claim 1, wherein:
said optical disk measures 0.6±0.03 mm from the surface of said optical disk to said first write layer, and
the sum of the length from the surface of said optical disk to said relay reflective layer and that from said relay reflective layer to said second write layer is 1.2±0.1 mm.

3. The optical disk, as claimed in claim 1, wherein:
said optical disk further comprises, enumerated in the direction of incidence of said write/read beam in the order of its travel, a first substrate,
a transparent adhesive layer between said first write layer and said second write layer, and
a second substrate behind said second write layer.

4. The optical disk, as claimed in claim 3, wherein:
the thickness of said second substrate is greater than 0.3 mm but less than 1.2 mm.

5. A method for manufacturing an optical disk, comprising:
A. forming a first write layer on one face of a first substrate;
B. forming a second write layer on one face of a second substrate;
C. forming a relay reflective layer on one face of a third substrate;
D. pasting together said first substrate and said second substrate with a transparent adhesive layer between them so that said first write layer and said second write layer be positioned inside; and
E. pasting together the face of said second substrate, out of said first substrate and said second substrate pasted together, reverse to the pasted face and said relay reflective layer of said third substrate with a transparent adhesive layer between them so that these faces be positioned inside.

6. A method for manufacturing an optical disk, comprising:
A. forming a first write layer on one face of a first substrate;
B. forming a second write layer on one face of a second substrate;
C. pasting together the first substrate and the second substrate with a transparent adhesive layer between them so that the first write layer and the second write layer be positioned inside; and
D. forming a relay reflective layer over the face of said second substrate, out of said first substrate and said second substrate pasted together, reverse to the pasted face.

7. An optical disk write/read device comprising:
an optical disk provided with, enumerated in the direction of incidence of a write/read beam in the order of its travel, a first substrate, a second substrate, and a relay reflective layer;
a light emitting unit for emitting said write/read beam;
a bifocal lens, and
a light receiving unit, wherein:
said bifocal lens, when writing onto or reading out of said first write layer is to be performed, focuses said write/read beam from the disk surface directly on said first write layer, or when writing onto or reading out of said second write layer is to be performed, focuses the beam on said second write layer after it is transmitted by said first write layer and said second write layer and reflected by said relay reflective layer; and
said light receiving unit receives a reflected read beam reflected after being focused on said first write layer or said second write layer.

8. The optical disk write/read device, as claimed in claim 7, further comprising:
a lens, between said bifocal lens and said light receiving unit, for condensing the reflected read beam reflected after being focused on said first write layer or said second write layer on a pinhole, and
said pinhole,
wherein, said light receiving unit receives the reflected read beam having passed said pinhole.

9. The optical disk write/read device, as claimed in claim 7, wherein:
said optical disk measures 0.6±0.03 mm from the surface of said optical disk to said first write layer, and
the sum of the length from the surface of said optical disk to said relay reflective layer and that from said relay reflective layer to said second write layer is 1.2±0.1 mm.

10. The optical disk write/read device, as claimed in claim 8, wherein:
said optical disk measures 0.6±0.03 mm from the surface of said optical disk to said first write layer, and
the sum of the length from the surface of said optical disk to said relay reflective layer and that from said relay reflective layer to said second write layer is 1.2±0.1 mm.

11. The optical disk write/read device, as claimed in claim 7, wherein:
said optical disk further comprises, enumerated in the direction of incidence of said write/read beam in the order of its travel, a first substrate,
a transparent adhesive layer between said first write layer and said second write layer,
a second substrate behind said second write layer, and
said relay reflective layer behind said second substrate.

12. The optical disk write/read device, as claimed in claim 8, wherein:
said optical disk further comprises, enumerated in the direction of incidence of said write/read beam in the order of its travel, a first substrate,
a transparent adhesive layer between said first write layer and said second write layer,
a second substrate behind said second write layer, and
said relay reflective layer behind said second substrate.

13. The optical disk write/read device, as claimed in claim 11, wherein:
the thickness of said second substrate is greater than 0.3 mm but less than 1.2 mm.

14. The optical disk write/read device, as claimed in claim 12, wherein:
the thickness of said second substrate is greater than 0.3 mm but less than 1.2 mm.

15. A method for writing/reading an optical disk provided with, enumerated in the direction of incidence of a write/read beam a first write layer, a second write layer and a relay reflective layer, comprising:
A. focusing said write/read beam, when writing onto or reading out of said first write layer is to be performed, from the disk surface directly on said first write layer, or
B. performing read/write, when writing onto or reading out of said second write layer, with said write/read beam focused on said second write layer after it is transmitted by said first write layer and said second write layer and reflected by said relay reflective layer.
